(19) United States
(12) Patent Application Publication
(10) Pub. No.: US 2025/0136456 A1
(43) Pub. Date: May 1, 2025

(54) Boric Acid Purification Process

(71) Applicant: U.S. Borax Inc., Wilmington, DE (US)

(72) Inventor: Daniel J. Suasnabar, Rancho Cucamonga, CA (US)

(21) Appl. No.: 18/836,076

(22) PCT Filed: Feb. 1, 2023
(86) PCT No.: PCT/US2023/061732

§ 371 Date: Aug. 6, 2024

Related U.S. Application Data
(60) Provisional application No. 63/307,236, filed on Feb. 7, 2022.

(51) Int. Cl. C01B 35/10; B01D 9/00; B01D 61/02; B01D 69/02; B01D 71/62

(52) U.S. Cl. CPC C01B 35/109; B01D 9/0004; B01D 61/0271; B01D 69/02; B01D 71/62; C01B 35/1036; B01D 2009/0086; B01D 2325/0283; C01P 2006/80

(57) ABSTRACT

The present disclosure is directed to a process. In an embodiment, the process includes providing a boric acid solution composed of from 10 wt % to 25 wt % boric acid at a temperature from 60° C. to less than 100° C. to form a heated boric acid solution. The process includes first passing the heated boric acid solution through a first nanofiltration membrane at a pressure from 300 psi to 500 psi to form a first heated boron permeate and second passing the first heated boron permeate through a second nanofiltration membrane at a pressure from 300 psi to 500 psi and forming a second heated boron permeate. The second heated boron permeate is composed of at least 10 wt % boric acid, less than 5 ppm sodium, and less than 5 ppm of a component selected from calcium, lithium, sulfur, and silicon.

### BACKGROUND

Boric acid is an inorganic boron chemical used in glass, glass fiber, ceramics, detergents, impregnation and protection chemicals, pharmaceuticals, cosmetics, pesticides, electrolytic capacitors, as well as in agriculture and nuclear power plants. Sulfate, heavy metal, alkali oxide, iron, chloride, arsenic and other water-insoluble compounds in boric acid are undesirable major impurities. The type and amount of impurity content determines the market value and the industrial area where boric acid will be used. As the amount of impurity increases, the economic value of boric acid decreases. The type and amount of impurity may vary depending on the boron mineral (tincal, colemanite, kernite, ulexite) used in its production, the inorganic acid used, the purification method and the efficiency of the equipment used in the purification process. The initial impurity in technical grade boric acid is the factor which determines the entire purification process.

Known processes for further purifying boric acid include ion exchange resin separation technology and subsequent recrystallization. Drawbacks of ion exchange resin include the need for chemicals and low throughput. In addition ion exchange resin is quickly polluted, compromising separation performance of this technology. Ion exchange technology is also disadvantageous because of the high cost for the regeneration fluid required for the ion exchange resin. Consequently the art recognizes the need for processes to purify boric acid other than ion exchange technology. The art further recognizes the need for processes that remove impurities of sodium, lithium, calcium, magnesium, iron, sulfate and chloride from boric acid.

### SUMMARY

The present disclosure is directed to a process. In an embodiment, the process includes providing a boric acid solution composed of from 10 wt % to 25 wt % boric acid at a temperature from 60° C. to less than 100° C. to form a heated boric acid solution. The process includes first passing the heated boric acid solution through a first nanofiltration membrane at a pressure from 300 psi to 500 psi to form a first heated boron permeate and second passing the first heated boron permeate through a second nanofiltration membrane at a pressure from 300 psi to 500 psi and forming a second heated boron permeate. The second heated boron permeate is composed of at least 10 wt % boric acid, less than 5 ppm sodium, and less than 5 ppm of a component selected from calcium, lithium, sulfur, and silicon.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The term “anhydrous” refers to a material containing no water.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

A “dalton” refers to the molecular weight of a compound and is equivalent to atomic mass unit.

The term “flux” for a membrane (such as a nanofiltration membrane) is the amount of permeate produced per unit area of membrane surface per unit time. Flux is expressed as gallons per square foot per day (GFD).

A “polymer” is a macromolecular compound prepared by polymerizing monomers of the same or different type. “Polymer” includes homopolymers, copolymers, terpolymers, interpolymers, and so on. An “interpolymer” is a polymer prepared by the polymerization of at least two types of monomers or comonomers. It includes, but is not limited to, copolymers (which usually refers to polymers prepared from two different types of monomers or comonomers, terpolymers (which usually refers to polymers prepared from three different types of monomers or comonomers), tetrapolymers (which usually refers to polymers prepared from four different types of monomers or comonomers), and the like.

### Test Methods

Inductively Coupled Plasma, ICP, is optical emission spectrometry whereby plasma energy is given to an analysis sample from outside, the component elements (atoms) are excited. When the excited atoms return to low energy position, emission rays (spectrum rays) are released and the emission rays that correspond to the photon wavelength are measured. The element type is determined based on the position of the photon rays, and the content of each element is determined based on the rays' intensity, with results reported in parts per million (ppm).

The ICP unit is Thermo Scientific iCAP 6000 Series ICP spectrometer. Calibration of the ICP spectrometer is performed using standard samples at different dilution factors (0, 0.1, 1.0 and 10). The boric acid solution is diluted 10×, 100×, etc. as needed so that when the samples are run with the ICP spectrometer, the reading is between 0.1 and 20. The boric acid samples are performed with the ICP spectrometer immediately after the calibration is accomplished.

Titration—Determination of weight percent B₂O₃ in solution is performed by way of the following procedure. For weight percent boric acid in solution, a factor of 1.776 is used to calculate the wt % boric acid content from B₂O₃ wt % (% wt B₂O₃×1.776=% wt boric acid).

### Reagents

1. Standardized Sodium Hydroxide, 0.5N-0.6N
2. Standardized Hydrochloric Acid, 0.5N-0.6N
3. Combined Indicator-prepare:
   a. 40 ml of 0.25% methylene blue in a 1:1 methanol-water solution
   b. 60 ml of 0.1% methyl red in methanol
   c. 90 ml of 1% phenolphthalein in isopropyl alcohol.
   d. combine the three indicator solutions to prepare a Combined Indicator solution
   e. other total volumes may be prepared, using the same proportions of reagents
4. Methyl Red Indicator-0.1% in methyl alcohol,
5. Mannitol-Commercial EDIBLE #10
   PROCEDURE
      Preparation and Titration of Sample
      1. Weigh about 1 g sample into a 400 ml tall-form beaker and record the weight (W) to nearest 0.001 g.
      2. Add about 75 ml of distilled water and heat to near boiling until dissolved. Allow to cool.
      3. Add 1-2 drops of methyl red indicator. From a burette, titrate with 0.5N standard HCl until solution turns pink/red. Add about 5 ml additional standard HCl. Record the total volume of acid as (V_{HCl1}).
      4. Boil for approximately 5 minutes to remove CO₂. Allow to cool and dilute with distilled water to a minimum volume of about 100 ml
      5. Back-titrate the excess HCl with standard 0.5N NaOH to the peach endpoint of methyl red.
      6. Add 10-12 drops combined indicator and adjust solution to the gray-blue (acidic) end-point, drop wise or by burette. (1 drop=0.05 mL). Record the volume of sodium hydroxide consumed as (V_{NaOH1}).
      7. To the solution from the Na₂O titration endpoint, add about 15 g mannitol (2-3 teaspoons) and titrate with standard 0.5N NaOH through green to blue-gray end-point.
      8. When the end-point is reached, add a further 2-3 g (½ teaspoon) mannitol. If this causes the end-point to fade, the titration must be continued.
      9. Repeat step 8 until a permanent end-point is reached. Record the total volume of NaOH as (V_{NaOH2}).
      10. If the end-point is passed (fuchsia color), add standard weak acid (0.05N) drop wise or by burette. Record this volume as this V_{WeakHCl}.
      CALCULATIONS
      A. NORMALITY METHOD:

$$\begin{matrix}\% {Na}_{2} O = \frac{( {V}_{HCl 1} \times {N}_{HCl} ) - ( {V}_{NaOH 1} \times {N}_{NaOH} )}{1000} \times \frac{61.98}{2} \times \frac{100}{W} \\ \frac{( {V}_{HCl 1} \times {N}_{HCl} ) - ( {V}_{NaOH 1} \times {N}_{NaOH} )}{W} \times 3.099\end{matrix} \\ \begin{matrix}\% {B}_{2} {O}_{3} = \frac{( {V}_{NaOH 2} \times {N}_{NaOH} ) - ( {V}_{WeakHCl} \times {N}_{WeakHCl} )}{1000} \times \frac{69.62}{2} \times \frac{100}{W} \\ = \frac{( {V}_{NaOH 2} \times {N}_{NaOH} ) - ( {V}_{WeakHCl} \times {N}_{WeakHCl} )}{W} \times 3.481\end{matrix}$$

where:
   W=Weight of sample in grams
   V_{HCl1}=Volume of HCl titrated for alkalinity in milliliters
   V_{NaOH1}=Volume of NaOH back-titrated in milliliters
   V_{NaOH2}=Volume of NaOH after mannitol added in milliliters
   V_{WeakHCl}=Volume of Weak HCl back-titrated in milliliters
   N_{HCl}=Normality of HCl solution
   N_{NaOH}=Normality of NaOH solution
   N_{WeakHCl}=Normality of “weak” HCl solution
Example
A 1.0002 g sample of borax 10-Mol required 9.51 ml of 0.5815N HCl and a back-titration of 0.50 ml of 0.5757N NaOH. After addition of mannitol, the sample required 18.26 mL of 0.5757N NaOH and a weak acid back-titration of 0.15 ml of 0.05815N HCl.

$$\begin{matrix}\% {Na}_{2} O = \frac{( 9.51 \times 0.5815 ) - ( 0.15 \times 0.5757 )}{1.0002} \times 3.099 \\ = 16.24 \%\end{matrix} \\ \begin{matrix}\% {B}_{2} {O}_{3} = \frac{( 18.24 \times 0.5757 ) - ( 0.15 \times 0.05815 )}{1.0002} \times 3.481 \\ = 36.52 \%\end{matrix} \\ \begin{matrix}\% {H}_{3} {BO}_{3} = \% {B}_{2} {O}_{3} \times 1.776 \\ = 36.52 \% \times 1.776 \\ = 64.86 \%\end{matrix}$$

### BRIEF DESCRIPTION OF THE DRAWING

FIG. 1 is a block diagram of a system for purifying boric acid, in accordance with an embodiment of the present disclosure.

### DETAILED DESCRIPTION

The present disclosure provides a process. In an embodiment, the process includes providing a heated boric acid solution. The heated boric acid solution includes from 10 wt % to 25 wt % boric acid and has a temperature from 60° C. to less than 100° C. The process includes first passing the heated boric acid solution through a first nanofiltration membrane at a pressure from 300 psi to 500 psi to form a first heated boron permeate. The process includes second passing the first heated boron permeate through a second nanofiltration membrane at a pressure from 300 psi to 500 psi to form a second heated boron permeate. The second heated boron permeate includes at least 10 wt % boric acid, less than 5 ppm sodium and less than 5 ppm of a component selected from calcium, lithium, sulfur, and silicon.

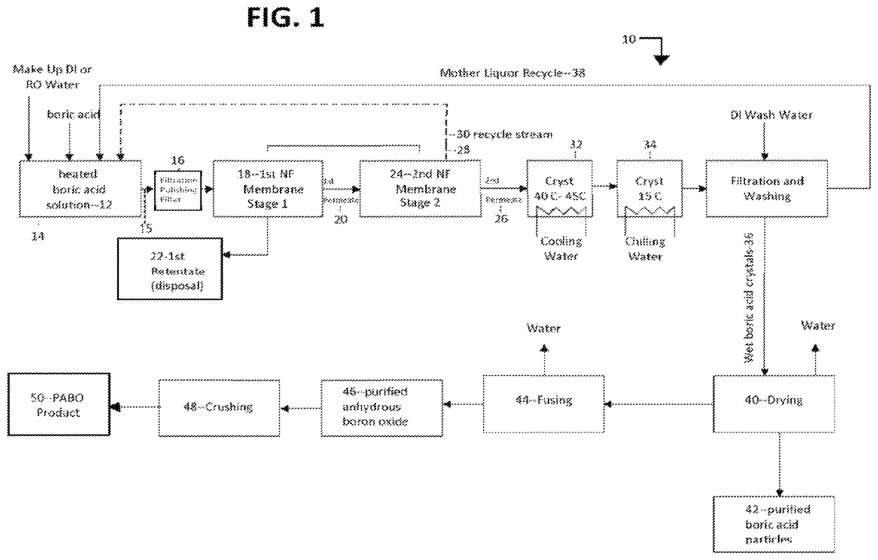

FIG. 1 is a block diagram of an embodiment of a system 10 wherein the present process may be performed. In an embodiment, the process includes providing a heated boric acid solution 12 in a feed tank 14. Boric acid (H₃BO₃, CAS 10043-35-3) is dissolved in deionized water (“DI”) to form a boric acid solution containing from 10 wt to 25 wt %, or from 10 wt % to 20 wt %, or from 10 wt % to 15 wt %, or from 11 wt % to 14 wt % boric acid. The boric acid has an impurity content of (i) from 70 ppm to 150 ppm sodium (Na), and/or (ii) from 50 ppm to 450 ppm sulfur (as sulfate SO₄), and/or (iii) from 10 ppm to 55 ppm silicon (as silica SiO₂), and/or (iv) from 5 ppm to 30 ppm potassium (K), and/or (v) from 1 ppm to 5 ppm iron (Fe). The boric acid is heated to a temperature from 60° C. to less than 100° C., or from 60° C. to 90° C., or from 60° C. to 80° C., or from 60° C. to less than 70° C. to form the heated boric acid solution. Feed tank 14 includes a heating member (not shown) to heat the boric acid solution. The heated boric acid solution has a pH from 3.0 to 4.5

In an embodiment, system 10 includes a filtration polishing filter 16 to remove any insoluble particles present in the heated boric acid solution 12.

The process includes first passing the heated boric acid solution 12 (by way of feed stream 15) through a first nanofiltration membrane 18 at a pressure from 300 to 500 pounds per square inch (psi) to form a first heated boron permeate 20 (interchangeably referred to as “stage 1” or “1^{st} stage”). Feed stream 15 carries the heated boric acid solution from the feed tank 14 to the first nanofiltration membrane 18. A “nanofiltration membrane,” (interchangeably referred to as “NF membrane”) as used herein, is a pressure-driven semi-permeable membrane with a pore size that restricts, or otherwise rejects, molecules, atoms, and/or ions with a molecular weight from 1000 daltons down to 200 daltons, or from 400 daltons to 200 daltons, or from 300 daltons to 200 daltons, or from 250 daltons to 210 daltons, or from 230 daltons to 215 daltons, or from 250 daltons to 150 daltons. NF membranes have a thickness from 50 nm to 90 nm.

A nanofiltration membrane is distinct from, and excludes, an ion exchange resin. Nanofiltration is directed to liquid-separation technology whereby NF membrane provides high rejection of ions. On the other hand, ion exchange is directed to a reversible interchange of charged particles—or ions—with those of like charge. This interchange of charged particles occurs when ions present on an insoluble ion exchange resin matrix effectively swap places with ions of a similar charge that are present in a surrounding solution. The present system and process exclude ion exchange resin and/or ion exchange separation.

Nonlimiting examples of suitable first NF membranes include ceramic NF membranes and polymeric NF membranes. A “ceramic nanofiltration membrane,” as used herein, is a nanofiltration membrane composed of aluminum oxide, silicon oxide, titanium oxide, zirconium oxide, and combinations thereof. Ceramic nanofiltration membrane may also include tin and/or hafnium as base elements.

A “polymeric nanofiltration membrane,” as used herein, is a nanofiltration membrane composed of one or more polymers. Suitable polymeric NF membranes include polyethersulfone NF membranes, polypiperazine amide NF membranes, and polyamide NF membranes. In an embodiment, the polymeric nanofiltration membrane is a polypiperazine amide NF membrane (such as TS40 membrane available from TriSep Corporation) or a polyamide nanofiltration membrane (such as a TS80 membrane available from TriSep Corporation).

The process includes first passing the heated boric acid solution 12 through the first NF membrane 18 at a pressure from 300 psi to 500 psi to form a first heated boron permeate 20. A “permeate” is the liquid that passes through the NF membrane. The “first heated boron permeate” is a solution at temperature from 60° C. to less than 100° C. that has passed through the first NF membrane and contains boron and/or boric acid. A pump, upstream of the first NF membrane, provides a pressure from 300 psi to 500 psi onto the heated boric acid solution 12 enabling the heated boric acid solution 12 to pass through the first NF membrane. The first passing step also produces a first retentate 22. A “retentate,” as used herein, is a liquid that does not pass through the NF membrane, the retentate containing retained particles on a side of the NF membrane opposite to the permeate.

In an embodiment, the first passing step occurs at a flux from 90 GFD to 120 GFD.

In an embodiment, the first retentate 22 is discarded as a waste stream.

The process includes second passing the first heated boron permeate 20 through a second nanofiltration membrane 24 at a pressure from 300 psi to 500 psi forming a second heated boron permeate 26 (interchangeably referred to as “stage 2” or “2^{nd} stage”). A pump, upstream of the second NF membrane 24, provides a pressure from 300 psi to 500 psi onto the first heated boron permeate 20 enabling the first heated boron permeate 20 to pass through the second NF membrane 24. The pump may be the same pump that is upstream to the first NF membrane 18 or may be a different pump. The first heated boron permeate is at a temperature from 60° C. to less than 100° C. as it passes through the second NF membrane 24. Passage of the heated boric acid solution through the first NF membrane 18 and the second NF membrane 24 removes impurities, yielding the second heated boron permeate. The “second heated boron permeate” is a solution at temperature from 60° C. to less than 100° C. that has passed through the second NF membrane 24 and contains (i) at least 10 wt % boron and/or boric acid, (ii) less than 5 ppm sodium (Na), and (iii) less than 5 ppm of a component selected from calcium (Ca), lithium (Li), sulfur(S), and silicon (Si).

The second NF membrane may be the same as the first NF membrane, or the second NF membrane may be different than the first NF membrane. Nonlimiting examples of suitable second NF membranes include ceramic NF membranes and polymeric NF membranes as disclosed above.

The second passing step also produces a second retentate 28. In an embodiment, the second retentate 28 is cycled, or recycled, back to the feed tank 14 by way of recycle stream 30. In this way, the second retentate 28 is combined with original heated boric acid solution 12 into the feed stream 15 for subsequent passage through the first NF membrane 18 and passage through the second NF membrane 24.

In an embodiment, the process includes providing a boric acid solution composed of from 10 wt % to 15 wt %, or from 10 wt % to 14 wt %, or from 11 wt % to 14 wt % boric acid at a temperature from 60° C. to less than 70° C. to form the heated boric acid solution. The process includes first passing the heated boric acid solution through a first nanofiltration membrane that is a polymeric nanofiltration membrane at a pressure from 300 psi to 500 psi, or from 350 psi to 450 psi, to form a first heated boron permeate. The first passing step occurs at a flux from 100 GFD to 110 GFD. The process includes second passing the first heated boron permeate through a second nanofiltration membrane that is a polymeric nanofiltration membrane at a pressure from 300 psi to 500 psi or from 350 psi to 450 psi. The first heated boron permeate is at a temperature from 60° C. to less than 70° C. as it passes through the second NF membrane that is a polymeric NF membrane. The second passing step occurs at a flux from 100 GFD to 110 GFD. In a further embodiment, the first polymeric NF membrane is composed of is a polypiperazine-amide NF membrane with a pore size from 250 daltons to 200 daltons, or from 250 daltons to 210 daltons, or from 230 daltons to 215 daltons, or from 250 daltons to 150 daltons, and a thickness from 50 nm to 90 nm and the second polymeric NF membrane is composed of polypiperazine-amide with a pore size from 250 daltons to 200 daltons, or from 250 daltons to 210 daltons, or from 230 daltons to 215 daltons, and a thickness from 50 nm to 90 nm. The process includes forming a second heated boron permeate composed of
(i) at least 10 wt % boron, or from 10 wt % to 15 wt % boron, or from 10 wt % to 14 wt % boron, or from 11 wt % to 13 wt % boron,
(ii) 0 ppm Na, or from greater than 0 ppm to 5 ppm Na, or from 1 ppm to 4 ppm Na,
(iii) 0 ppm Ca, or from greater than 0 ppm to 3 ppm Ca, or from 0.1 ppm to 1 ppm Ca,
(iv) 0 ppm Li, or from greater than 0 ppm to 3 ppm Li, or from 0.1 ppm to 1 ppm Li,
(v) 0 ppm S, or from greater than 0 ppm to 3 ppm S, or from 0.1 ppm to 2 ppm S, from 0.1 ppm to 1 ppm S, and
(vi) 0 ppm Si, or from greater than 0 ppm to 4 ppm Si, or from 0.1 ppm to 3 ppm Si, from 0.5 ppm to 3 ppm Si.

In an embodiment, the process includes cooling the second heated boron permeate to form a second boron permeate, and crystallizing the second boron permeate to form wet boric acid crystals. The wet boric acid crystals are subsequently separated, washed, and dried to form purified boric acid particles. The purified boric acid particles are composed of (i) at least 99.999 wt % boric acid, (ii) less than 5 ppm sodium (Na), and (iii) less than 5 ppm of a component selected from calcium (Ca), lithium (Li), sulfur(S), and silicon (Si) (based on total weight of the purified boric acid particles).

In an embodiment, the second heated boron permeate 26 is first cooled to a temperature from 40° C. to 45° C., as shown in step 32 in FIG. 1. The cooled second boron permeate is subsequently crystallized in deionized water at a temperature from 10° C. to 25° C., or from 15° C. to 22° C. (step 34 of FIG. 1) to form wet boric acid crystals 36. The wet boric acid crystals 36 are separated from the mother liquor and are washed with water at a temperature from 10° C. to 25° C. Nonlimiting examples of water suitable for washing the crystals include deionized water, distilled water, reverse osmosis (RO) water, water treated by carbon filtration, and water treated by ion exchange. In a further embodiment, the wet boric acid crystals 36 are separated from the mother liquor and are washed with deionized water at a temperature from 10° C. to 25° C., or washed with deionized water at a temperature from 15° C. to 22° C.

In an embodiment, one or more crystallizers are used to cool and/or crystallize boric acid from the second heated boron permeate. A “crystallizer” is an apparatus with a heat exchanger, a separator, and a circulation pump which super-saturates a solution by evaporating the solvent of the saturated solution. The solute of the supersaturated solution then cools, forming crystals. A “forced-circulation crystallizer” is an evaporative crystallizer. The second heated boron permeate is introduced into a first forced circulation crystallizer (at step 32) at a temperature from 40° C. to 45° C. to form a cooled second boron permeate. The cooled second boron permeate is subsequently passed through a second forced-circulation crystallizer (at step 34) at a temperature from 10° C. to 25° C. crystallizing the boric acid into wet boric acid crystals 36. The wet boric acid crystals 36 are separated from the mother liquor and are washed with deionized water at a temperature from 10° C. to 25° C., or washed with deionized water at a temperature from 15° C. to 22° C.

In an embodiment, a mother liquor recycle stream 38 is cycled, or recycled, back to the feed tank 14.

In an embodiment, the process includes drying (step 40 in FIG. 1) the wet boric acid crystals 36 in an oven from 90° C. to 110° C. for from 15 minutes to 45 minutes to remove water from the wet boric acid crystals and form purified boric acid particles 42. The purified boric acid particles 42 are composed of
(i) at least 99.999 wt % boron acid,
(ii) 0 ppm Na, or from greater than 0 ppm to 5 ppm Na, or from 1 ppm to 4 ppm Na,
(iii) 0 ppm Ca, or from greater than 0 ppm to 3 ppm Ca, or from 0.1 ppm to 1 ppm Ca,
(iv) 0 ppm Li, or from greater than 0 ppm to 3 ppm Li, or from 0.1 ppm to 1 ppm Li,
(v) 0 ppm S, or from greater than 0 ppm to 3 ppm S, or from 0.1 ppm to 2 ppm S, from 0.1 ppm to 1 ppm S, and
(vi) 0 ppm Si, or from greater than 0 ppm to 4 ppm Si, or from 0.1 ppm to 3 ppm Si, from 0.5 ppm to 3 ppm Si (based on total weight of the purified boric acid particles).

In an embodiment, the process includes heating the purified boric acid particles 42 in a furnace (such as a muffler furnace, for example) to a temperature from 650° C. to 750° C. from 30 minutes to 2 hours. The 650° C. to 750° C. furnace temperature (step 44 FIG. 1) removes all, or substantially all water molecules from the purified boric acid and fuses the purified boric acid to form a purified anhydrous boron oxide 46 (B₂O₃), which is subsequently cooled to ambient temperature.

In an embodiment, the process includes crushing, grinding, and/or sieving (step 48, FIG. 1) the purified anhydrous boron oxide 46 to a desired particle size to form a purified anhydrous boron oxide (PABO) product 50. The purified anhydrous boron oxide product 50 is composed of
(i) at least 99.999 wt % boron oxide (B₂O₃),
(ii) 0 ppm Na, or from greater than 0 ppm to 5 ppm Na, or from 1 ppm to 4 ppm Na,
(iii) 0 ppm Ca, or from greater than 0 ppm to 3 ppm Ca, or from 0.1 ppm to 1 ppm Ca,
(iv) 0 ppm Li, or from greater than 0 ppm to 3 ppm Li, or from 0.1 ppm to 1 ppm Li,
(v) 0 ppm S, or from greater than 0 ppm to 3 ppm S, or from 0.1 ppm to 2 ppm S, from 0.1 ppm to 1 ppm S, and
(vi) 0 ppm Si, or from greater than 0 ppm to 4 ppm Si, or from 0.1 ppm to 3 ppm Si, from 0.5 ppm to 3 ppm Si (based on total weight of the purified anhydrous boron oxide product).

Applicant discovered the present process unexpectedly provides for a more simple (lower operational costs and lower equipment costs), more environmentally-friendly, less energy-intensive compared to conventional boron purification processes, and in particular compared to boron purification processes utilizing ion exchange resin technology.

By way of example, and not limitation, some embodiments of the present disclosure will now be described in detail in the following examples.

### Examples

In a feed tank, 12.4 g boric acid (H₃BO₃, CAS 10043-35-3) (OPTIBOR from Rio Tinto) was added to 100 ml water, mixed and heated to 65° C. to form a heated boric acid solution with 11 wt % boric acid (Example 1). 15.6 g boric acid (H₃BO₃, CAS 10043-35-3) (OPTIBOR from Rio Tinto) was added to 100 ml water, mixed and heated to 65° C. to form a heated boric acid solution with 13.5 wt % boric acid (Example 2).

A recirculation two-stage system (as shown by system 10 in FIG. 1) with two nanofiltration membrane units is set to operate at a membrane pressure of 500 psi. The permeate line is diverted to a separate permeate tank (not shown) to receive the permeate, with retentate recycled back to the feed tank. The permeate flow rate was measured at timed intervals to determine flux produced by the system at various levels of concentration. The feed stream became more concentrated as permeate was removed. Each example run (Example 1 and Example 2) was completed when not enough original feed solution remained in the feed tank.

First stage (1S). A feed stream with the heated boric acid solution from the feed tank is passed (first pass) through a TS-40 NF membrane (first NF membrane) to form the first heated boron permeate and the first retentate. The first heated boron permeate is stored in the permeate tank. The first retentate is cycled (or recycled) back to the feed tank. Recycled retentate is combined with the heated boric acid permeate in the feed tank. The feed stream continues to be passed through the first NF membrane at a temperature of 65° C. The feed solution becomes more concentrated as the first retentate is continuously recycled back into the feed tank and the first heated boron permeate is removed.

In Tables 1-3 below, “R80 Perm” indicates the feed stream is 80 vol % initial boric acid solution/20 vol % retentate, “R75 Perm” indicates the feed stream is 75 vol % initial boric acid solution/25 vol % retentate, “R67 Perm” indicates the feed stream is 67 vol % initial boric acid solution/33 vol % retentate, and “R50 Perm” indicates the feed stream is 50 vol % initial boric acid solution/50 vol % retentate, “Final Perm” indicates the final boron permeate (or first boron permeate) upon completion of the first stage (or second stage) nanofiltration, and “Final reten” indicates the final retenate upon completion of the first stage (or second stage) nanofiltration. Completion of the first stage nanofiltration yields a first boron permeate and a first retentate (or final first retentate).

Second stage (2S). The permeate from the first stage (the first boron permeate) stored in the permeate tank (from the first stage) is transferred to the feed tank and is heated to 65° C.

A feed stream with the first heated boron permeate from the feed tank is passed (second pass) through the TS-40 NF membrane (second NF membrane) to form the second heated boron permeate and the second retentate. The second heated boron permeate is stored in the permeate tank. The second retentate is cycled (or recycled) back to the feed tank. Recycled retentate is combined with the first heated boric acid permeate in the feed tank. The feed stream continues to be passed through the second NF membrane. The feed solution becomes more concentrated as the second heated retentate is continuously recycled back into the feed tank and the second heated boron permeate is removed.

The second heated boron permeate is cooled in cooling water at a temperature from 40° C. to 45° C. The second boron permeate is passed through a forced-circulation crystallizer at a temperature of 22° C. or 15° C. crystallizing the boric acid into wet boric acid crystals. The wet boric acid crystals are filtered and washed with deionized water.

Properties of the first heated boron permeate, the second boron permeate and for Example 1 and Example 2 are provided in respective Table 1A and Table 1B below.

TABLE 1A
Example 1 -- 11 wt % initial boric acid solution (values are ppm except BA is wt %)

| | | | | | | | | | | | | | | | BA* by |
|---|---|---|---|---|---|---|---|---|---|---|---|---|---|---|---|
| Sample | | | | | | | | | | | | | | | titration |
| ID | 1st stage (1st pass) | As | Ca | Cu | Fe | K | Li | Mg | Na | Ni | Pb | S | Si | Zn | % |
| 1 | 1S Initial Feed | 0.4 | 2.7 | 2.1 | 1.2 | | 1.1 | 1.2 | 62.8 | | | 39.5 | 1.4 | 0.7 | 11.29 |
| 2 | 1S R85 Perm | 0.3 | 0.7 | 0.4 | | | 0.4 | | 19.9 | | | 8.3 | 1.0 | | 11.09 |
| 3 | 1S R80 Perm | 0.3 | 0.8 | 0.4 | | | 0.4 | | 19.6 | | | 8.2 | 0.9 | | 11.11 |
| 4 | 1S R75 Perm | 0.3 | 0.8 | 0.3 | | | | | 15.2 | | | 8.1 | 0.8 | | 11.14 |
| 5 | 1S R67 Perm | | 0.9 | | | | | | 10.7 | | | 7.0 | 0.6 | | 10.91 |
| 6 | 1S R50 Perm | | 1.2 | | | | | | 7.9 | | | 6.6 | 0.4 | | 10.40 |
| 7 | 1S Final Perm | 0.3 | 0.8 | 0.5 | | | 0.4 | | 23.2 | | | 8.7 | 1.1 | | 10.38 |
| 8 | 1S Final Reten | 1.1 | 57.0 | | 10.0 | 7.8 | 8.7 | 20.8 | 1305.0 | 0.7 | 1.4 | 455.4 | 7.1 | 14.3 | 10.27 |
| | 2nd stage | 2nd | pass | | | | | | | | | | | | |
| 9 | 2S Initial Feed | 0.3 | 0.8 | 0.5 | | | 0.4 | | 23.2 | | | 8.7 | 1.1 | | 10.38 |
| 10 | 2S R85 Perm | | 0.3 | | | | | | 3.6 | | | 1.0 | 2.1 | | 10.72 |
| 11 | 2S R80 Perm | | | | | | | | 3.1 | | | 0.9 | 2.0 | | 10.60 |
| 12 | 2S R75 Perm | | 0.3 | | | | | | 2.7 | | | 0.9 | 1.9 | | 10.44 |
| 13 | 2S R67 Perm | | 0.4 | | | | | | 2.2 | | | 0.9 | 1.8 | | 10.32 |
| 14 | 2S R50 Perm | | 0.4 | | | | | | 1.7 | | | 0.8 | 1.6 | | 10.17 |
| 15 | 2S Max Comp | | 0.3 | | | | | | 3.9 | | | 1.1 | 2.2 | | 10.86 |
| 16 | 2S Final Reten | 1.2 | 32.5 | | 2.2 | 4.7 | 3.8 | 6.8 | | 0.7 | 1.4 | | 8.4 | 25.4 | 11.16 |

*BA—boric acid

TABLE 1B
Example 2 -- 13.5 wt % initial boric acid solution (values are ppm except BA is wt %)

| | | | | | | | | | | | | BA* by |
|---|---|---|---|---|---|---|---|---|---|---|---|---|
| Sample | | | | | | | | | | | | titration |
| ID | 1st stage (1st pass) | Ca | Cu | Fe | Mg | Na | Ni | Pb | S | Si | Zn | % |
| 17 | 1S Initial Feed | 2.8 | 3.1 | | 0.6 | 18.1 | | | 10.2 | 2.0 | 0.9 | 13.25 |
| 18 | 1S R85 Perm | 0.5 | | | <0.1 | 2.8 | | | 3.2 | 0.5 | | 12.91 |
| 19 | 1S R80 Perm | 0.4 | | | <0.1 | 2.5 | | | 3.3 | 0.5 | | 12.76 |
| 20 | 1S R75 Perm | 0.5 | | | <0.1 | 2.4 | | | 3.2 | 0.5 | | 12.66 |
| 21 | 1S R67 Perm | 0.5 | | | <0.1 | 2.2 | | | 3.0 | 0.5 | | 12.43 |
| 22 | 1S R50 Perm | 0.7 | | | <0.1 | 1.6 | | | 3.2 | 0.5 | | 12.06 |
| 23 | 1S Max Perm | 0.6 | 0.3 | | <0.1 | 3.3 | | | 3.6 | 0.6 | | 13.17 |
| 24 | 1S Final Reten | 29.0 | | 2.8 | 6.3 | 259.3 | | | | 10.9 | 27.2 | — |
| | 2nd stage | 2nd | pass | | | | | | | | | |
| 25 | 2S Initial Feed | 0.6 | 0.3 | | <0.1 | 3.3 | | | 3.6 | 0.6 | | 13.17 |
| 26 | 2S R90 Perm | 0.3 | 0.5 | | | 2.9 | | | | 1.1 | | 11.37 |
| 27 | 2S R85 Perm | 0.4 | 0.4 | | | 2.7 | | | | 1.0 | | 11.18 |
| 28 | 2S R80 Perm | 0.4 | 0.4 | | | 2.7 | | | | 1.0 | | 11.07 |
| 29 | 2S R75 Perm | 0.4 | 0.3 | | | 2.5 | | | | 0.9 | | 10.88 |
| 30 | 2S R67 Perm | 0.4 | | | | 3.3 | | | | 0.8 | | 10.52 |
| 31 | 2S R50 Perm | 0.4 | | | | 2.4 | | | | 0.8 | | 10.12 |
| 32 | 2S Max Perm | 0.4 | 0.5 | | | 3.2 | | | | 1.2 | | 11.64 |
| 33 | 2S Final Reten | 34.1 | | 2.1 | 7.1 | 28.5 | 0.4 | | 45.1 | 6.3 | 24.0 | — |

*BA—boric acid

Portions of the boron permeate in Example 2 (13.5 wt % initial boron solution, Table 2) are crystallized to form wet boric acid crystals after different stages of nanofiltration and at different temperatures for analysis. A portion of the Example 2 boron permeate is crystallized after the first stage (after first pass) at a temperature of 22° C. A second portion of the Example 2 boron permeate is crystallized after the second stage (second pass) at a temperature of 22° C.

A third portion of the Example 2 permeate is crystallized after the first stage (first pass) at a temperature of 15° C. A fourth portion of the Example 2 boron permeate is crystallized after the second stage (second pass) at a temperature of 15° C. For each case, properties of the wet boric acid crystals are shown in Tables 2A-2B below. In Tables 2A-2B, the numeric value in the Sample ID corresponds to the Sample ID in Tables 1A-1B. The samples in Tables 2A-2B are unwashed filter cakes of wet boric acid crystals.

TABLE 2A
Post 1st stage crystallization and post 2nd stage crystallization
of Example 2 boron permeate at 22° C. (in ppm)

| Sample | 1st Stage | | | | | | | | |
|---|---|---|---|---|---|---|---|---|---|
| ID | (1st pass) | Na | B | Ca | Cu | Fe | S | Si | Zn |
| 18-crys | 1S R85 Perm | 1.3 | 184,689 | | | | | | |
| 20-crys | 1S R75 Perm | 1.2 | 177,785 | | | | | | |
| 22-crys | 1S R50 Perm | 3.4 | 176,953 | 19 | | | | | |
| | 2nd Stage | | | | | | | | |
| | (2nd pass) | | | | | | | | |
| 26-crys | 2S R85 Perm | 1.5 | — | | | | | | |
| 28-crys | 2S R75 Perm | 0.9 | — | | | | | | |
| 30-crys | 2S R50 Perm | 2.3 | — | | | | | | |
| 32-crys | 2S Max Perm | 2.1 | — | | | | | | |

TABLE 2B
Post 1st stage crystallization and post 2nd stage crystallization
of Example 2 boron permeate at 15° C. (in ppm)

| Sample | 1st Stage | Na | B | Ca | Cu | Fe | S | Si | Zn |
|---|---|---|---|---|---|---|---|---|---|
| ID | (1st pass) | | | | | | | | |
| 18-crys | 1S R85 Perm | 2.1 | 181,101 | | | | | | |
| 20-crys | 1S R75 Perm | 1.6 | 163,780 | | | | | | |
| 22-crys | 1S R50 Perm | 1.3 | 170,741 | | | | | | |
| | 2nd Stage | | | | | | | | |
| | (2nd pass) | | | | | | | | |
| 26-crys | 2S R85 Perm | 1.0 | — | 1 | | | 1 | | |
| 28-crys | 2S R75 Perm | | — | | | | | | |
| 30-crys | 2S R50 Perm | 1.3 | — | 1 | | | 1 | | |
| 32-crys | 2S Max Perm | 2.1 | — | | | | | | |

The wet boric acid crystals from Table 2A are washed with deionized water at 22° C. The wet boric acid crystals from Table 2B are washed in deionized water at a temperature of 15° C. The washed wet boric acid crystals are then dried in an oven (Cole Parmer StableTemp Mechanical Convection oven 5.3 cu ft 120 VAC) at 100° C. for 1 hour (or until constant weight is achieved), yielding purified boric acid particles. The purified boric acid particles (“PBAP”) have the following properties, shown in Table 2C below.

TABLE 2C
purified boric acid particles

| Sample | | Na | Boric acid | | | | | | |
|---|---|---|---|---|---|---|---|---|---|
| ID | Crystallized from | (ppm) | (wt %) | Ca | Cu | Fe | S | Si | Zn |
| PBAP-1 | 18-crys (1S R85 Perm) | 1.5 | 99.9996 | <0.1 | <0.1 | <0.1 | <0.1 | <0.1 | <0.1 |
| PBAP-2 | 20-crys (1S R75 Perm) | 0.9 | 99.9998 | <0.1 | <0.1 | <0.1 | <0.1 | <0.1 | <0.1 |
| PBAP-3 | 22-crys (1S R50 Perm) | 2.1 | 99.9994 | <0.1 | <0.1 | <0.1 | <0.1 | <0.1 | <0.1 |
| PBAP-4 | 26-crys (2S R85 Perm) | 1.6 | 99.9996 | <0.1 | <0.1 | <0.1 | <0.1 | <0.1 | <0.1 |
| PBAP-5 | 28-crys (2S R75 Perm) | 1.5 | 99.9996 | <0.1 | <0.1 | <0.1 | <0.1 | <0.1 | <0.1 |
| PBAP-6 | 30-crys (2S R50 Perm) | 1.0 | 99.9993 | 1 | <0.1 | <0.1 | <0.1 | 1 | <0.1 |
| PBAP-7 | 32-crys (2S Max Perm) | 1.3 | 99.9992 | 1 | <0.1 | <0.1 | <0.1 | 1 | <0.1 |

The purified boric acid particles are fused to yield anhydrous boron oxide. In each example, glassware and platinum (Pt) crucibles are cleaned with hot 3% HCl solution. Purified boric acid particles are placed in the Pt crucible. The loaded Pt crucible is placed in a muffle furnace. The loaded Pt crucible is heated to 200° C. for 15 minutes. The temperature of the muffle furnace is then increased to 300° C. for 30 minutes. The muffle furnace temperature is then increased to 700° C. for 30 minutes. The muffle furnace is cooled to ambient temperature, yielding purified anhydrous boron oxide. After cooling, the purified anhydrous boron oxide is analyzed to determine sodium content as shown in Table 3 below.

TABLE 3
Purified anhydrous boron oxide

| | | Purified Anhydrous |
|---|---|---|
| Sample ID | Source | Boron oxide |
| 1-B₂O₃ | PBAP-5 from 28-crys (2S R75 | Boron oxide* |
| (anhydrous) | Perm, 22 C.) Boric Acid | 99.9989 wt % |
| | 99.9996 wt % Na 1.5 ppm | Na 4.21 ppm |
| 2-B₂O₃ | PBAP-6 from 30-crys (2S R50 | Boron oxide* |
| (anhydrous) | Perm, 22 C.) Boric Acid | 99.9990 wt % |
| | 99.9998 wt % Na 1.0 ppm | Na 3.90 ppm |

*Ca, Cu, Fe, S, Si, Zn each individually less than 1 ppm

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
providing a boric acid solution comprising from 10 wt % to 25 wt % boric acid at a temperature from 60° C. to less than 100° C. to form a heated boric acid solution;
first passing the heated boric acid solution through a first nanofiltration membrane at a pressure from 300 psi to 500 psi to form a first heated boron permeate;
second passing the first heated boron permeate through a second nanofiltration membrane at a pressure from 300 psi to 500 psi; and
forming a second heated boron permeate comprising
at least 10 wt % boric acid,
less than 5 ppm sodium, and
less than 5 ppm of a component selected from the group consisting of Ca, Li, S, and Si.

2. The process of claim 1 comprising first passing the heated boric acid solution through a first nanofiltration membrane selected from the group consisting of a ceramic nanofiltration membrane and a polymeric nanofiltration membrane; and
second passing the first heated boron permeate through a second nanofiltration membrane selected from the group consisting of a ceramic nanofiltration membrane and a polymeric nanofiltration membrane.

3. The process of claim 1 comprising
providing a boric acid solution comprising from 10 wt % to 15 wt % boric acid at a temperature from 60° C. to less than 70° C. to form a heated boric acid solution;
first passing the heated boric acid solution through a first nanofiltration membrane that is a polymeric nanofiltration membrane at a pressure from 300 psi to 500 psi to form a first heated boron permeate;
second passing the first heated boron permeate through a second nanofiltration membrane that is a polymeric nanofiltration membrane at a pressure from 300 psi to 500 psi; and
forming a second heated boron permeate comprising
at least 10 wt % boric acid,
less than 5 ppm sodium, and
less than 5 ppm of a material selected from the group consisting of Ca, Li, S, and Si.

4. The process of claim 3 wherein the first polymeric nanofiltration membrane has a pore size from 150 daltons to 250 daltons and the second polymeric nanofiltration membrane has a pore size from 150 daltons to 250 daltons.

5. The process of claim 1 wherein the first passing occurs at a flux from 100 GFD to 110 GFD.

6. The process of claim 5 wherein the second passing occurs at a flux from 100 GFD to 110 GFD.

7. The process of claim 1 comprising
cooling the second heated boron permeate to form a second boron permeate;
crystallizing the second boron permeate to form wet boric acid crystals;
drying the wet boric acid crystals; and
forming purified boric acid particles composed of
at least 99.999% wt % boric acid;
less than 5 ppm sodium, and
less than 5 ppm of a material selected from the group consisting of Ca, Li, S, and Si.

8. The process of claim 7 comprising
heating the purified boric acid particles to a temperature from 650° C. to 750° C.; and
forming a purified anhydrous boron oxide composed of
at least 99.999 wt % boron oxide;
less than 5 ppm sodium; and
less than 5 ppm of a material selected from the group consisting of Ca, Li, S, and Si.
